(19) United States
(12) Patent Application Publication
(10) Pub. No.: US 2025/0225201 A1
(43) Pub. Date: Jul. 10, 2025

(54) FORMULATION SYSTEM, FORMULATION METHOD, AND RECORDING MEDIUM

(71) Applicant: NEC Corporation, Minato-ku, Tokyo (JP)

(72) Inventors: Ryutaro Doi, Tokyo (JP); Yuki Susa, Tokyo (JP)

(73) Assignee: NEC Corporation, Minato-ku, Tokyo (JP)

(21) Appl. No.: 18/285,745

(22) PCT Filed: May 19, 2023
(86) PCT No.: PCT/JP2023/018823

§ 371 Date: Oct. 5, 2023

(51) Int. Cl. G06F 17/18

(52) U.S. Cl. CPC G06F 17/18

(57) ABSTRACT

An artificial intelligence (AI) system includes an update unit and a transformation unit. The update unit updates at least one of an upper limit value and a lower limit value of an inequality constraint included in an optimization problem so as to reduce a range between the upper limit value and the lower limit value of the inequality constraint. The transformation unit transforms the updated inequality constraint into an equality constraint by using an auxiliary variable having a domain determined by the upper limit value and the lower limit value of the updated inequality constraint.

### TECHNICAL FIELD

The present disclosure relates to a formulation system and the like.

### BACKGROUND ART

Practical social problems in a wide range of fields may be formulated into a combinatorial optimization problem. The optimization problem is a problem of obtaining a solution that minimizes or maximizes an objective function from solutions that satisfy a constraint condition. For example, PTL 1 discloses a technique of dynamically adding a constraint during solving processing.

Many combinatorial optimization problems are classified as non-deterministic polynomial time (NP) hard problems. That is, in many combinatorial optimization problems, the number of combinations explosively increases as a scale of the problem increases, and thus it is difficult to find an optimal solution within a realistic time frame. Therefore, for example, a quantum annealing technology is known as a main method of solving combinatorial optimization problems.

In the quantum annealing technology, a combinatorial optimization problem to be solved is formulated in the form called quadratic unconstrained binary optimization (QUBO) or Ising model. The combinatorial optimization problem may have a constraint condition regarding a variable in addition to an objective function. For example, constraints included in the optimization problem include an equality constraint and an inequality constraint. NPL 1 discloses a technique of formulating the inequality constraint as the QUBO. In the technique disclosed in NPL 1, an auxiliary variable is newly introduced to formulate the inequality constraint.

### CITATION LIST

### Patent Literature

PTL 1: JP 07-064967 A
PTL 2: JP 2020-201598 A

### Non Patent Literature

NPL 1: Andrew Lucas, “Ising formulations of many NP problems,” Frontiers in Physics, vol. 2, 2014

### SUMMARY OF INVENTION

### Technical Problem

For example, in an optimization problem, an auxiliary variable may be introduced when an inequality constraint is formulated. In a case where the auxiliary variable is encoded by using a plurality of new variables whose number changes in accordance with a domain of the auxiliary variable, for example, binary variables, the number of new variables necessary for encoding increases as the domain is wider. When the number of variables used in the optimization problem increases, a solution space becomes wider, and thus it may be difficult to solve the optimization problem.

An object of the present disclosure is to provide a formulation system and the like that improve efficiency of solving an optimization problem.

### Solution to Problem

A formulation system according to an aspect of the present disclosure includes an update means that updates at least one of an upper limit value and a lower limit value of an inequality constraint included in an optimization problem in such a way as to reduce a range between the upper limit value and the lower limit value of the inequality constraint, and a transformation means that transforms the updated inequality constraint into an equality constraint by using an auxiliary variable having a domain determined by the upper limit value and the lower limit value of the updated inequality constraint.

In a formulation method according to an aspect of the present disclosure, a computer executes processing of updating at least one of an upper limit value and a lower limit value of an inequality constraint included in an optimization problem in such a way as to reduce a range between the upper limit value and the lower limit value of the inequality constraint, and transforming the updated inequality constraint into an equality constraint by using an auxiliary variable having a domain determined by the upper limit value and the lower limit value of the updated inequality constraint.

A program according to an aspect of the present disclosure causes a computer to execute processing of updating at least one of an upper limit value and a lower limit value of an inequality constraint included in an optimization problem in such a way as to reduce a range between the upper limit value and the lower limit value of the inequality constraint, and transforming the updated inequality constraint into an equality constraint by using an auxiliary variable having a domain determined by the upper limit value and the lower limit value of the updated inequality constraint.

Each program may be stored in a non-transitory computer-readable recording medium.

### Advantageous Effects of Invention

According to the present disclosure, it is possible to improve efficiency of solving an optimization problem.

### BRIEF DESCRIPTION OF DRAWINGS

FIG. 1 is a first block diagram showing a configuration example of a formulation system according to the present disclosure.

FIG. 2 is an explanatory diagram showing an example where ranges between upper limit values and lower limit values overlap in different inequality constraints.

FIG. 3 is an explanatory diagram showing an example where ranges between upper limit values and lower limit values do not overlap in different inequality constraints.

FIG. 4 is a flowchart showing an operation example of a formulation system.

FIG. 5 is an explanatory diagram showing an example of connection between an optimization system and another device.

FIG. 6 is a second block diagram showing a configuration example of an optimization system according to the present disclosure.

FIG. 7 is an explanatory diagram showing an example of a plurality of inequality constraints included in an optimization problem.

FIG. 8 is an explanatory diagram showing a plurality of inequality constraints and an example where coefficients and ranges are specified from the constraints.

FIG. 9 is an explanatory diagram showing an update example by integration of Equations (a) and (b).

FIG. 10 is an explanatory diagram showing an update example by overlap between a maximum value and minimum value of each constraint and a range thereof.

FIG. 11 is an explanatory diagram showing a formulation example.

FIG. 12 is a flowchart (part 1) showing an operation example of an optimization system.

FIG. 13 is a flowchart (part 2) showing the operation example of the optimization system.

FIG. 14 is an explanatory diagram showing a hardware configuration example of a computer.

### EXAMPLE EMBODIMENT

Hereinafter, example embodiments of a formulation system, an optimization system, a formulation method, an optimization method, a program, and a non-transitory recording medium in which the program is recorded according to the present disclosure will be described in detail with reference to the drawings. The present example embodiments do not limit the disclosed technique.

First, formulation in a combinatorial optimization problem will be briefly described. In particular, an example where an auxiliary variable is introduced when an inequality constraint condition is formulated will be described. The constraint condition included in the combinatorial optimization problem may be simply referred to as a constraint.

As described above, the quantum annealing technology is known as a main method of solving combinatorial optimization problems. In the quantum annealing technology, a combinatorial optimization problem is formulated in the form called QUBO or Ising model. Both the QUBO and the Ising model use binary variables. The QUBO uses a binary variable of 0 or 1. The Ising model uses a binary variable of −1 or 1. Meanwhile, when a variable in the QUBO is denoted by x, and a variable in the Ising model is denoted by s, the QUBO and the Ising model can be equivalently transformed by Equation 1.

$$S = 2 x - 1 \qquad [ Equation 1 ]$$

Because the QUBO and the Ising model can be equivalently transformed, the QUBO will be described as an example, but the same applies to the Ising model.

As shown in Equation 2, the QUBO is expressed in the form of a quadratic objective function H by using N binary variables x of 0 or 1.

A combinatorial optimization problem to be solved is formulated as Qᵢⱼ in Equation 2. The QUBO is a problem of obtaining a combination of allocation of the variables to 0 or 1 such that the objective function has a minimum value, and, by interpreting the obtained values of the variables, it is possible to obtain a solution to the combinatorial optimization problem to be originally solved.

$$H = {\sum }_{i = 1}^{N} {\sum }_{j = 1}^{i} {Q}_{ij} {x}_{i} {x}_{j} \qquad [ Equation 2 ]$$

Many of combinatorial optimization problems have a constraint condition regarding a variable in addition to an objective function. In the QUBO, a constraint condition is formulated as a penalty term and is added to the objective function. The method is called a penalty method or a penalty function method. The penalty term is an equation having a small value when the constraint condition is satisfied and having a large value when the constraint condition is not satisfied. For example, a constraint condition in which the number of variables having a value of 1 among n binary variables x₁, . . . , xₙ is one is also called a one-hot constraint. The one-hot constraint can be expressed by Equation 3. When the one-hot constraint is set to the penalty term of the QUBO, formulation is performed in the form of Equation 4 by moving the right side of Equation 3 to the left side and squaring the entire left side. Equation 4 takes a minimum value of 0 only when the one-hot constraint is satisfied, that is, when Equation 3 holds, and takes a positive value when the constraint is not satisfied. The QUBO is a problem of minimizing an equation obtained by adding an objective function and a penalty term, and thus it is possible to find a solution that minimizes the objective function while satisfying a constraint condition expressed by the penalty term.

$${\sum }_{i = 1}^{n} {x}_{i} = 1 \qquad [ Equation 3 ]$$

$${( {\sum }_{i = 1}^{n} {x}_{i} - 1 )}^{2} \qquad [ Equation 4 ]$$

The constraint condition that can be expressed by an equation can be formulated as the QUBO by the above method. Meanwhile, an inequality constraint condition cannot be formulated as it is. As described above, NPL 1 discloses a technique of formulating an inequality constraint as the QUBO. In the method, an auxiliary variable is newly introduced to formulate the inequality constraint. As an example, a procedure of formulating an inequality constraint shown in Equation 5 as the QUBO will be described. In Equation 5, xᵢ denotes a binary variable or an integer variable, and a lower limit value 1, an upper limit value u, and a coefficient aᵢ denote integer constants.

$$l \leq \underbrace{{\sum }_{i = 1}^{n} {a}_{i} {x}_{i} \leq u}_{P} \qquad [ Equation 5 ]$$

First, an auxiliary variable y is introduced. The auxiliary variable y is an integer variable taking a free value within a range from the lower limit value 0 to the upper limit value u−1 as shown in Equation 6. However, because variables in the QUBO are limited to binary variables, y serving as an integer variable is encoded by using a binary variable. Examples of the encoding method include log encoding, one-hot encoding, and unary encoding. For example, the log encoding uses a binary number, and, in a case where an integer variable having the lower limit value of 0 and the upper limit value of 7 is encoded, the integer variable is expressed by using a binary variable bᵢ as shown in Equation 7. Even in a case where any one of the log encoding, the one-hot encoding, and the unary encoding is used, the number of binary variables required for encoding increases as a domain of the integer variable increases.

$$0 \leq y \leq u - l \qquad [ Equation 6 ]$$

$${2}^{0} \times {b}_{0} + {2}^{1} \times {b}_{1} + {2}^{2} \times {b}_{2} \qquad [ Equation 7 ]$$

After the auxiliary variable y is introduced, the inequality constraint of Equation 5 can be expressed by adding a penalty term shown in Equation 8. Equation 8 corresponds to a penalty term showing an equality constraint in Equation 9. In other words, a penalty expression of an inequality using an auxiliary variable corresponds to transformation from an inequality constraint to an equality constraint. From Equation 6, 1+y is a term that takes a free value within a range shown in Equation 10, that is, within the range from the lower limit value 1 to the upper limit value u of Equation 5 that is the original inequality. Therefore, in a case where a side P of Equation 5 satisfies Equation 5, the entire Equation 8 serving as the penalty term becomes the minimum value, i.e., 0 when 1+y takes a value equal to the side P. Meanwhile, in a case where the side P does not satisfy Equation 5, the entire Equation 8 has a positive value even if 1+y takes any value within the range of Equation 10. Therefore, by adding the penalty term of Equation 8 and the objective function, it is possible to minimize the objective function while satisfying the inequality constraint of Equation 5.

$${( {\sum }_{i = 1}^{n} {a}_{i} {x}_{i} - ( l + y ) )}^{2} \qquad [ Equation 8 ]$$

$${\sum }_{i = 1}^{n} {a}_{i} {x}_{i} = l + y \qquad [ Equation 9 ]$$

$$l \leq l + y \leq u \qquad [ Equation 10 ]$$

Thus, the inequality constraint can be transformed into the equality constraint by using the auxiliary variable in the penalty method. As described above, in a case where the auxiliary variable is encoded by using a plurality of new variables whose number changes in accordance with a domain of the auxiliary variable, for example, binary variables, the number of new variables necessary for encoding increases as the domain is wider. When the number of variables used in the optimization problem increases, a solution space becomes wider, and thus it may be difficult to solve the optimization problem.

In example embodiments, efficiency of solving an optimization problem is improved by reducing a range between an upper limit value and a lower limit value of an inequality constraint.

### First Example Embodiment

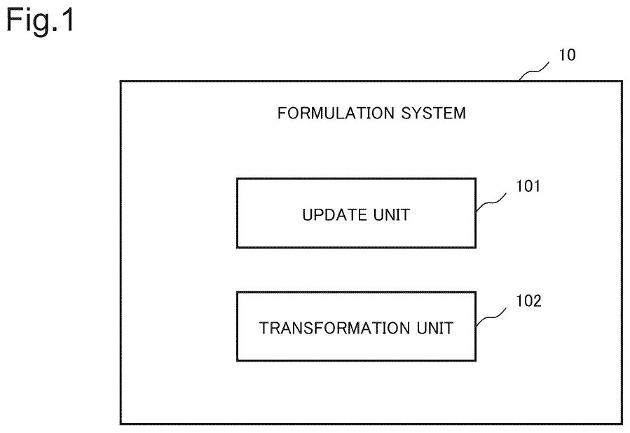

First, a basic function example of a formulation system will be described in a first example embodiment. FIG. 1 is a first block diagram showing a configuration example of a formulation system according to the present disclosure. A formulation system 10 includes an update unit 101 and a transformation unit 102.

The update unit 101 updates at least one of an upper limit value and a lower limit value of an inequality constraint included in an optimization problem so as to reduce a range between the upper limit value and the lower limit value of the inequality constraint. In particular, for example, the update unit 101 updates at least one of the upper limit value and the lower limit value of the inequality constraint included in the optimization problem so as to minimize the range between the upper limit value and the lower limit value of the inequality constraint.

Examples of the update method include an update example by integrating a plurality of constraints and an update example by narrowing down the upper limit value and the lower limit value in accordance with a domain of a variable.

### Integration Example

First, the update example by integrating a plurality of constraints will be described. For example, the update unit 101 updates at least one of the upper limit value and the lower limit value of the inequality constraint by integrating the inequality constraint with another constraint included in the optimization problem. The another constraint may be an equality constraint or an inequality constraint as long as the another constraint can be integrated with the inequality constraint.

More specifically, for example, in a case where a variable and a coefficient in the inequality constraint match with a variable and a coefficient in the another constraint included in the optimization problem, the update unit 101 integrates the inequality constraint with the another constraint. Here, an example of integrating two inequality constraints will be described by using Equations 11 and 12, for example.

$${l}_{1} \leq {\sum }_{i = 1}^{n} {a}_{i} {x}_{i} \leq {u}_{1} \qquad [ Equation 11 ]$$

$${l}_{2} \leq {\sum }_{i = 1}^{n} {a}_{i} {x}_{i} \leq {u}_{2} \qquad [ Equation 12 ]$$

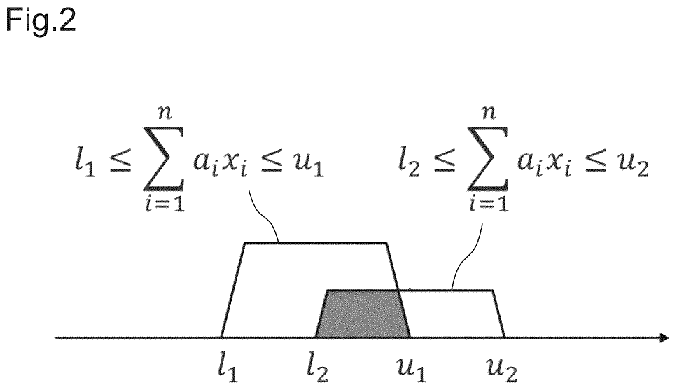

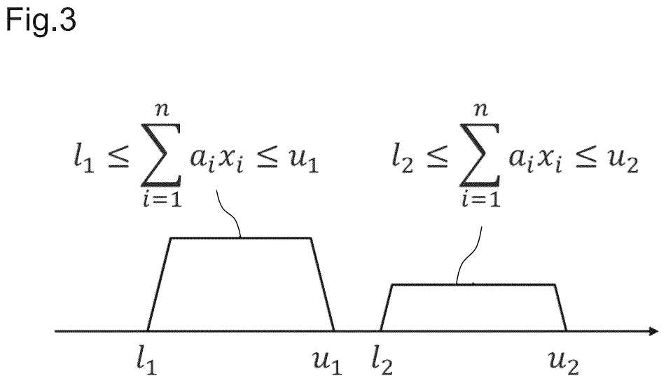

In Equations 11 and 12, the variable is xᵢ, and the coefficient is aᵢ. The upper limit value of Equation 11 is u₁, and the lower limit value thereof is l₁. The upper limit value of Equation 12 is u₂, and the lower limit value thereof is l₂. As described above, in Equations 11 and 12, the variables and the coefficients match, but the upper limit values and the lower limit values are different. A range between the upper limit value u₂ and the lower limit value l₂ and a range between the upper limit value u₁ and the lower limit value l₁ will be described with reference to FIGS. 2 and 3.

FIG. 2 is an explanatory diagram showing an example where ranges between upper limit values and lower limit values overlap in different inequality constraints. As shown in FIG. 2, in a case where the ranges between the upper limit values and the lower limit values of the two inequalities overlap, a range satisfying both the inequalities is from l₂ to u₁.

FIG. 3 is an explanatory diagram showing an example where ranges between upper limit values and lower limit values do not overlap in different inequality constraints. As shown in FIG. 3, in a case where the ranges between the upper limit values and the lower limit values of the two inequalities do not overlap, both the inequalities cannot be simultaneously satisfied. Because the inequality constraints conflict, there is no solution that satisfies all the constraint conditions included in the combinatorial optimization problem.

In a case where the variable and the coefficient in the inequality constraint match with the variable and the coefficient in the another constraint included in the optimization problem, and the range between the upper limit value and the lower limit value of the inequality constraint overlap with the range between the upper limit value and the lower limit value of the another constraint, the update unit 101 integrates the inequality constraint with the another constraint. For example, the update unit 101 can integrate Equation 11 with Equation 12 as shown in Equation 13. More specifically, the update unit 101 sets a smaller one of the upper limit values of the two inequality constraints as an integrated upper limit value and also sets a larger one of the lower limit values of the two inequality constraints as an integrated lower limit value.

$$max ( {l}_{1} , {l}_{2} ) \leq {\sum }_{i = 1}^{n} {a}_{i} {x}_{i} \leq min ( {u}_{1} , {u}_{2} ) \qquad [ Equation 13 ]$$

Although an example of integrating a plurality of inequality constraints has been described, an inequality constraint and an equality constraint may be integrated. An example where Equation 11 that is an inequality and Equation 14 that is the following equality are given as constraints will be described.

$${\sum }_{i = 1}^{n} {a}_{i} {x}_{i} = c \qquad [ Equation 14 ]$$

In a case where ranges between lower limit values and upper limit values of Equations 11 and 14 overlap, that is, in a case where a condition in which c is equal to or more than l₁ and equal to or less than u₁ is satisfied, the update unit 101 can integrate Equation 11 with Equation 14. In other words, the constraint of Equation 11 is unnecessary. Meanwhile, in a case where the ranges between the lower limit values and the upper limit values of Equations 11 and 14 do not overlap, that is, in a case where the condition in which c is equal to or more than l₁ and equal to or less than u₁ is not satisfied, the constraint of Equation 11 and the constraint of Equation 14 cannot be simultaneously satisfied. Because the inequality constraint and the equality constraint conflict, there is no solution that satisfies all the constraint conditions included in the combinatorial optimization problem.

### <Narrowing-Down Example>

Next, an update example by narrowing down the upper limit value and the lower limit value in accordance with a domain of a variable will be described. A domain is set for each variable in the combinatorial optimization problem. For example, in a case where the variable is a binary variable of 0 or 1, a domain thereof is set from 0 to 1. In a case where the variable is an integer variable showing some number, the domain is non-negative, that is, the lower limit value of the domain is 0. In some cases, the update unit 101 can update at least one of the upper limit value and the lower limit value of the inequality constraint based on the domain of the variable.

The update unit 101 updates at least one of the upper limit value and the lower limit value of the inequality constraint based on at least one of a minimum value and a maximum value of a range calculated from a domain of a variable and a coefficient multiplied by the variable in the inequality constraint. First, specifically, for example, the update unit 101 calculates at least one of the minimum value and the maximum value of the range calculated from the domain of the variable and the coefficient multiplied by the variable in the inequality constraint. An inequality constraint shown in Equation 15 will be described as an example.

$$\underbrace{{\sum }_{i = 1}^{n} {a}_{i} {x}_{i}}_{P} \leq u \qquad [ Equation 15 ]$$

In Equation 15, aᵢ denotes a positive integer constant, and xᵢ denotes a binary variable of 0 or 1. The update unit 101 can calculate a possible range of the left side of Equation 15 in consideration of a domain of xᵢ. For example, a range of a side P serving as the left side of Equation 15 takes a minimum value of 0 when all xᵢ are 0. The range of the side P serving as the left side of Equation 15 takes a maximum value (total value of a₁ to aₙ) when all xᵢ are 1. The update unit 101 can update the upper limit value and the lower limit value of Equation 15 based on the maximum value and the minimum value. For example, the update unit 101 can update Equation 15 to Equation 16.

$$max ( - ∞ , 0 ) {\sum }_{i = 1}^{n} {a}_{i} {x}_{i} \leq min ( u , {\sum }_{i = 1}^{n} {a}_{i} ) \qquad [ Equation 16 ]$$

There is no lower limit value in Equation 15, but the update unit 101 can update the lower limit value to 0 based on the range calculated from the domain of the variable as shown in Equation 16. As shown in Equation 16, there is a possibility that the upper limit value can also be updated.

Meanwhile, in a case where the range calculated from the domain of the variable does not overlap with the range between the upper limit value and the lower limit value of the inequality constraint, the constraint cannot be satisfied. Therefore, there is no solution that satisfies the constraint conditions included in the combinatorial optimization problem.

Hereinabove, description of the two update examples ends.

Next, the transformation unit 102 transforms the updated inequality constraint into an equality constraint by using the penalty method. For example, the transformation unit 102 formulates a penalty term by adding an auxiliary variable to the inequality constraint based on the penalty method. Specifically, the transformation unit 102 may perform formulation as shown in Equations 6 and 8.

When transforming the updated inequality constraint into an equality constraint by using the penalty method, the transformation unit 102 sets a domain of the auxiliary variable to a range smaller than a difference between the upper limit value and the lower limit value of the inequality. Then, the transformation unit 102 formulates the penalty term by using the set small range. The formulation will be described by using the inequality constraint shown in Equation 5 as an example.

First, the transformation unit 102 sets a domain of the auxiliary variable y to be introduced into Equation 5 as shown in Equation 17. The domain of the auxiliary variable y in Equation 17 is narrower than the domain of the auxiliary variable y in Equation 6. Then, the transformation unit 102 adds the auxiliary variable y to the inequality constraint in Equation 5 by using the set domain in Equation 17 based on the penalty method, thereby formulating the penalty term. The formulated constraint is shown in Equation 18.

In a case where a portion M in Equation 18 is 0 or 1, the entire Equation 18 takes the minimum value of 0, and, in a case where the portion M in Equation 18 is other than 0 or 1, the entire Equation 18 has a positive value. In a case where a portion T in Equation 18 falls within the range of Equation 5, a value of the auxiliary variable y is determined such that the entire Equation 18 has 0. Note that the portion T in Equation 18 is the same as the side P in Equation 5. Meanwhile, in a case where the portion T does not fall within the range of Equation 5, in other words, in a region where the constraint is not satisfied, the penalty term is introduced such that the entire Equation 18 has a positive value regardless of the value of the auxiliary variable y. Because the domain of the auxiliary variable is changed, it is possible to reduce the number of binary variables when encoding the auxiliary variable.

$$0 \leq y \leq u - l - 1 \qquad [ Equation 17 ]$$

$${( \underbrace{\underbrace{{\sum }_{i = 1}^{n} {a}_{i} {x}_{i}}_{T} - ( l + y ) -}_{M} 0.5 )}^{2} - 0.25 \qquad [ Equation 18 ]$$

An example of reducing auxiliary variables when the inequality constraint is formulated as the QUBO by the penalty method will be described. Equations 19 and 20 will be described as examples. For example, an example of introducing an auxiliary variable y₁ into Equation 19 is shown in Equation 21. For example, an example of introducing an auxiliary variable y₂ into Equation 20 is shown in Equation 22. When each auxiliary variable is encoded with a binary variable in, for example, the log encoding, four binary variables for the auxiliary variable y₁ and four binary variables for the auxiliary variable y₂, i.e., eight binary variables in total are required. Meanwhile, the update unit 101 can integrate Equation 19 with Equation 20. For example, an equation obtained by integrating Equations 19 and 20 is shown in Equation 23. For example, an example of introducing an auxiliary variable y₃ into Equation 23 is shown in Equation 24. When the log encoding is taken as an example, three binary variables are required for the auxiliary variable y₃.

$$- 9 \leq 4 {x}_{1} - 2 {x}_{2} \leq 6 \qquad [ Equation 19 ]$$

$$- 1 \leq 4 {x}_{1} - 2 {x}_{2} \leq 7 \qquad [ Equation 20 ]$$

$$0 \leq {y}_{1} \leq 6 - ( - 9 ) = 15 \qquad [ Equation 21 ]$$

$$0 \leq {y}_{2} \leq 7 - ( - 1 ) = 8 \qquad [ Equation 22 ]$$

$$- 1 \leq 4 {x}_{1} - 2 {x}_{2} \leq 6 \qquad [ Equation 23 ]$$

$$0 \leq {y}_{3} \leq 6 - ( - 1 ) = 7 \qquad [ Equation 24 ]$$

### (Flowchart)

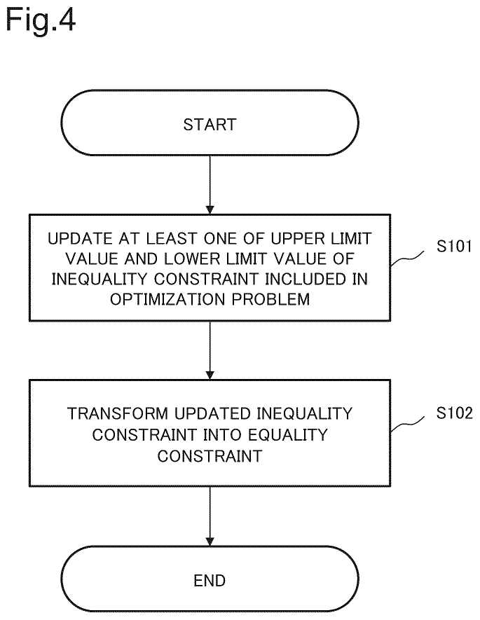

FIG. 4 is a flowchart showing an operation example of the formulation system 10. The update unit 101 updates at least one of an upper limit value and a lower limit value of an inequality constraint included in an optimization problem so as to reduce a range between the upper limit value and the lower limit value of the inequality constraint (step S101). Next, the transformation unit 102 transforms the updated inequality constraint into an equality constraint by using the penalty method (step S102).

Hereinabove, in the first example embodiment, at least one of an upper limit value and a lower limit value of an inequality constraint included in an optimization problem is updated so as to reduce a range between the upper limit value and the lower limit value of the inequality constraint, and the updated inequality constraint is transformed into an equality constraint. Thus, reducing a range of the inequality makes it possible to reduce the number of auxiliary variables when the inequality constraint is expressed by the auxiliary variables by using the penalty method. Therefore, it is possible to suppress expansion of the solution space and to improve the efficiency of solving an optimization problem.

The formulation system 10 encodes an auxiliary variable by using a plurality of new variables whose number changes in accordance with a domain of the auxiliary variable. This makes it possible to reduce the number of binary variables when encoding the auxiliary variable.

### Second Example Embodiment

Next, a second example embodiment will be described in detail with reference to the drawings. In the second example embodiment, an example of updating a range between an upper limit value and a lower limit value of an inequality constraint so as to reduce the range will be described by using a specific example of an inequality included in a combinatorial optimization problem. In the second example embodiment, an example of solving an optimization problem including a formulated constraint will be described. Therefore, an optimization system including the functional units of the formulation system 10 described in the first example embodiment will be described.

Hereinafter, description overlapping with the above description will be omitted as long as the description of the present second example embodiment is clear.

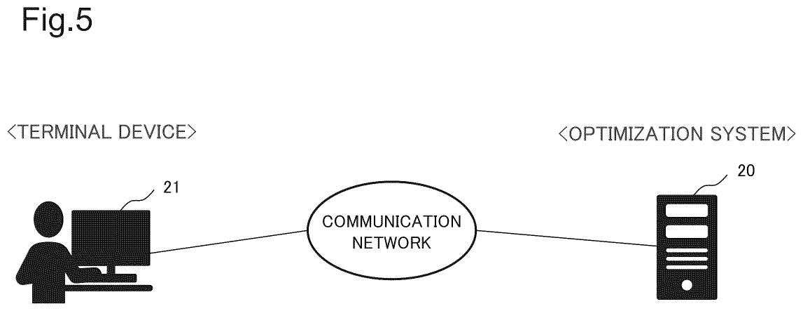

FIG. 5 is an explanatory diagram showing an example of connection between an optimization system and another device. For example, an optimization system 20 is connected to a terminal device 21 via a communication network. The terminal device 21 is, for example, the terminal device 21 of a user.

In FIG. 5, the type of the terminal device 21 is not particularly limited and may be a personal computer (PC), a smartphone, a tablet device, or the like. The terminal device 21 may transmit information to the optimization system 20, or an application program capable of outputting information from the optimization system 20 may be installed in the terminal device 21 in advance.

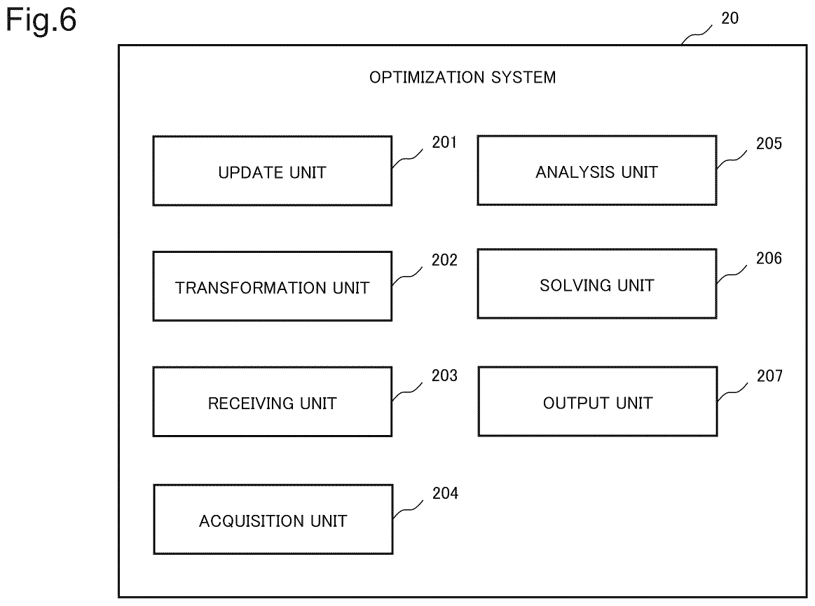

FIG. 6 is a second block diagram showing a configuration example of the optimization system 20 according to the present disclosure. The optimization system 20 includes an update unit 201, a transformation unit 202, a receiving unit 203, an acquisition unit 204, an analysis unit 205, a solving unit 206, and an output unit 207.

The update unit 201 may have the function of the update unit 101 in FIG. 1 as a basic function. The transformation unit 202 may have the function of the transformation unit 102 in FIG. 1 as a basic function.

The receiving unit 203 receives input of data regarding a constraint condition of the user for an optimization problem. For example, the receiving unit 203 receives input of data regarding a constraint condition of the user for an optimization problem via the terminal device 21 of the user.

Here, a wide variety of practical social problems, such as distribution planning, digital marketing, and drug discovery, can be shown as a combinatorial optimization problem. For example, in the distribution planning, there is a combinatorial optimization problem of searching for a transport route having the smallest total moving distance or transport time from among a large number of transport routes. For example, the user is a consignor, and the user inputs a departure base, a transit point, an arrival base, a departure time, an arrival time, an amount of baggage, and the like via the terminal device 21. The receiving unit 203 receives those inputs as conditions of the user for the optimization problem.

The acquisition unit 204 acquires information regarding the optimization problem. The information regarding the optimization problem indicate constraints representing an objective function and the condition of the user.

The analysis unit 205 analyzes the information regarding the optimization problem. Specifically, for example, the analysis unit 205 specifies a variable, a coefficient multiplied by the variable, an upper limit value, and a lower limit value for each inequality constraint included in the optimization problem.

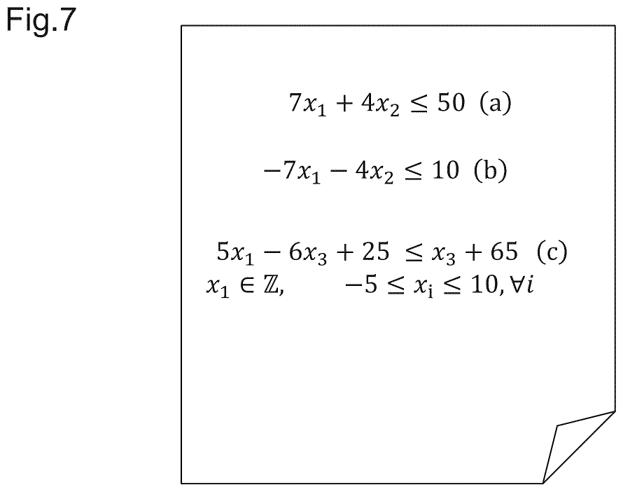

FIG. 7 is an explanatory diagram showing an example of a plurality of inequality constraints included in the optimization problem. In FIG. 7, different inequality constraints of Equations (a), (b), and (c) will be described as examples.

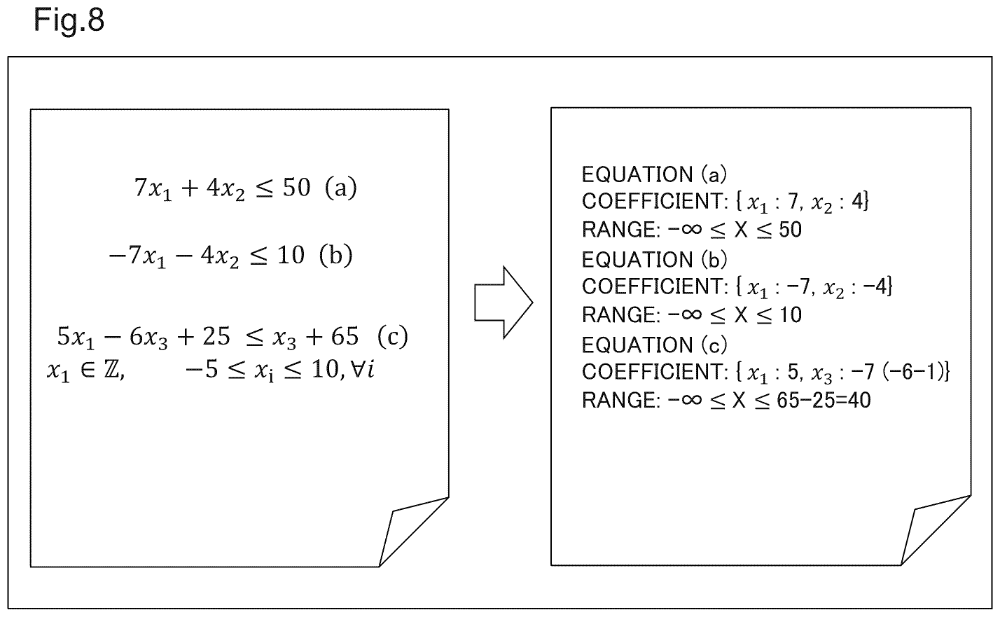

FIG. 8 is an explanatory diagram showing an example of the plurality of inequality constraints and an example where coefficients and ranges are specified from the constraints. In FIG. 8, for example, the analysis unit 205 specifies variables, coefficients, upper limit values, and lower limit values from the constraints included in the optimization problem and transforms the specified variables, coefficients, upper limit values, and lower limit values into data in a dictionary format.

As shown in FIG. 8, in Equation (a), variables are x₁ and x₂, a coefficient of the variable x₁ is 7, and a coefficient of the variable x₂ is 4. The range is equal to or more than −∞ and equal to or less than 50.

As shown in FIG. 8, in Equation (b), variables are x₁ and x₂, a coefficient of the variable x₁ is −7, and a coefficient of the variable x₂ is −4. The range is equal to or more than −∞ and equal to or less than 10.

As shown in FIG. 8, in Equation (c), variables are x₁ and x₃, a coefficient of the variable x₁ is 5, and a coefficient of the variable x₃ is −7. The range is equal to or more than −∞ and equal to or less than 40.

Next, the update unit 201 updates at least one of the upper limit value and the lower limit value of each inequality constraint included the optimization problem so as to reduce a range between the upper limit value and the lower limit value of the inequality constraint. A specific update method is as described in the first example embodiment. An update example will be specifically described by using Equations (a), (b), and (c) shown in FIG. 8.

First, an update example by integrating a plurality of constraints will be described. For each of the inequality constraints, the update unit 201 specifies another constraint matching with the variables and the coefficients in the inequality constraint. Here, “matching of the variables and the coefficients” means that the variables and the coefficients are determined to match even if signs thereof are inverted. In a case where there is a plurality of variables in a plurality of different constraints, and signs of respective coefficients of the plurality of variables are inverted, the variables and the coefficients are determined to match. For example, the sign of the coefficient of the variable x₁ in Equation (a) matches with inversion of the sign of the coefficient of the variable x₁ in Equation (b), and the sign of the coefficient of the variable x₂ in Equation (a) matches with inversion of the sign of the coefficient of the variable x₂ in Equation (b). The variables and the coefficients in Equation (c) are different from the variables and the coefficients in Equation (a). The variables and the coefficients in Equation (c) are different from the variables and the coefficients in Equation (b).

Next, in a case where the variable and the coefficient in the inequality constraint match with the variable and the coefficient in the another constraint included in the optimization problem, and a range between the upper limit value and the lower limit value of the inequality constraint overlaps with a range between the upper limit value and the lower limit value of the another constraint, the update unit 201 integrates the inequality constraint with the another constraint.

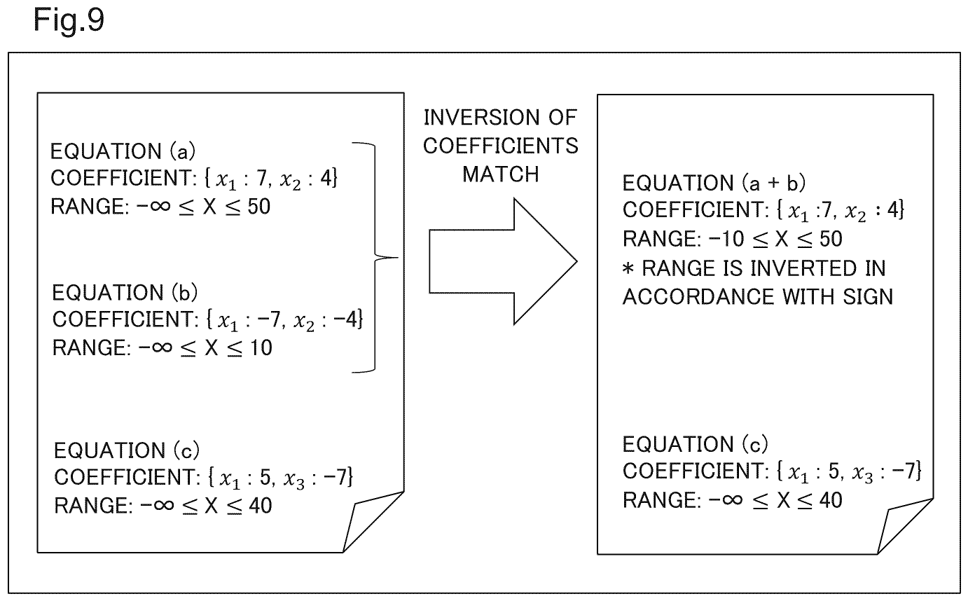

FIG. 9 is an explanatory diagram showing an update example by integration of Expressions (a) and (b). A range between the upper limit value and the lower limit value of Equation (a) overlaps with a range between the upper limit value and the lower limit value of Equation (b), and thus the update unit 201 integrates Equations (a) and (b). For example, the signs in Equations (a) and (b) are inverted, and thus the range is also inverted. In FIG. 9, the integrated equation is shown as Equation (a+b). For example, in Equation (a+b), the lower limit value is −10, and the upper limit value is 50. Thus, the range between the upper limit value and the lower limit value of Equation (a+b) is narrower than those of Equations (a) and (b).

Here, an example where the variable and the coefficient in the inequality constraint match with the variable and the coefficient in the another constraint, and the range between the upper limit value and the lower limit value of the inequality constraint overlaps with the range between the upper limit value and the lower limit value of the another constraint has been described. Meanwhile, there is a case where, even if the variable and the coefficient in the inequality constraint match with the variable and the coefficient in the another constraint, the range between the upper limit value and the lower limit value of the inequality constraint does not overlap with the range between the upper limit value and the lower limit value of the another constraint. In such a case, as described in the first example embodiment, there is no solution that satisfies all the constraint conditions included in the optimization problem.

Therefore, in a case where the range between the upper limit value and the lower limit value of the inequality constraint does not overlap with the range between the upper limit value and the lower limit value of the another constraint, the output unit 207 outputs the fact that no solution to the optimization problem can be obtained. For example, the output unit 207 may notify the user that no solution to the optimization problem can be obtained by using an electronic mail, an electronic message, or the like. For example, the output unit 207 may output the fact that no solution to the optimization problem can be obtained to the terminal device 21 of the user. The output method to the terminal device 21 of the user is not particularly limited and may be display on a display device of the terminal device 21 or audio output to an audio output device of the terminal device 21.

For example, the output unit 207 outputs the fact that the inequality constraint and the another constraint conflict. In other words, for example, the output unit 207 may output the fact that there is no solution satisfying both the constraints. For example, when displaying a plurality of constraint conditions of the optimization problem on the terminal device 21, the output unit 207 may display conflicting constraint conditions among the plurality of constraint conditions in an identifiable manner. More specifically, for example, the output unit 207 may emphasize the conflicting constraints. Therefore, the user can confirm which constraint cannot be satisfied. This makes it possible to easily change the condition of the user for the optimization problem.

Next, an update example by narrowing down the upper limit value and the lower limit value in accordance with a domain of a variable will be described. As described in the first example embodiment, the update unit 201 first calculates a minimum value and a maximum value of a range based on a domain of a variable and a coefficient multiplied by the variable in each inequality constraint.

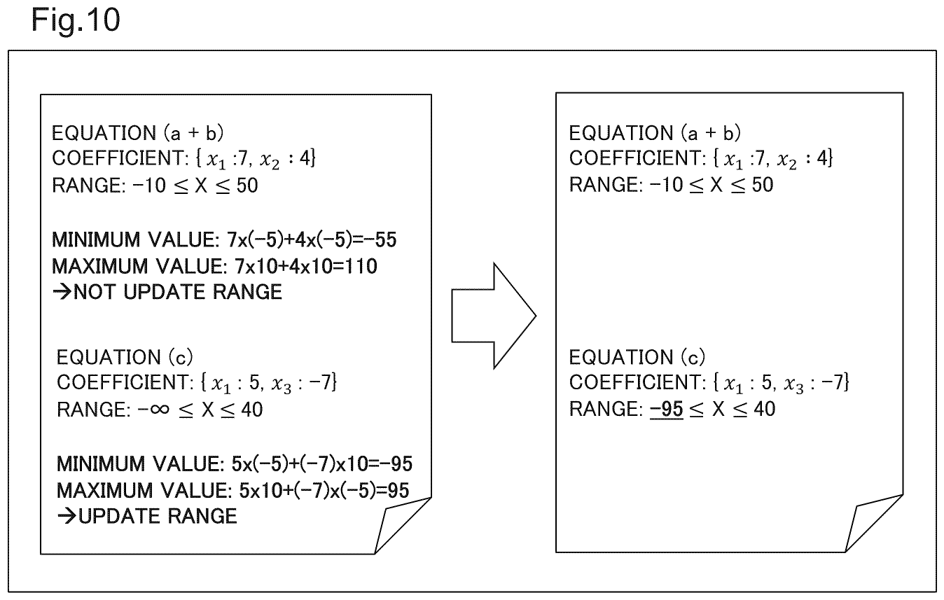

FIG. 10 is an explanatory diagram showing an update example by overlap between a maximum value and minimum value of each constraint and a range thereof. The update unit 201 calculates a minimum value and a maximum value of Equation (a+b). In Equation (a+b), the minimum value is −55, and the maximum value is 110. Although a range between the maximum value and the minimum value overlaps with a range between the upper limit value and the lower limit value, the range between the upper limit value and the lower limit value fall within the range between the maximum value and the minimum value. Therefore, the update unit 201 does not update the range of Equation (a+b).

Next, the update unit 201 calculates a maximum value and a minimum value of Equation (c). In Equation (c), the minimum value is −95, and the maximum value is 95. In Equation (c), a range between the maximum value and the minimum value overlaps with a range between the upper limit value and the lower limit value. The lower limit value of Equation (c) can be updated to −95. Therefore, the update unit 201 updates the lower limit value of Equation (c) to −95. This narrows the range between the upper limit value and the lower limit value of Equation (c).

Here, there has been described an example where the range between the maximum value and the minimum value calculated from the domain of the variable and the coefficient multiplied by the variable in the inequality constraint overlaps with the range between the upper limit value and the lower limit value of the inequality constraint. There is a case where the range between the maximum value and the minimum value calculated from the domain of the variable and the coefficient multiplied by the variable in the inequality constraint does not overlap with the range between the upper limit value and the lower limit value of the inequality constraint. In such a case, as described in the first example embodiment, there is no solution that satisfies the constraint conditions included in the optimization problem.

Therefore, in a case where the range between the maximum value and the minimum value calculated from the domain of the variable and the coefficient multiplied by the variable in the inequality constraint does not overlap with the range between the upper limit value and the lower limit value of the inequality constraint, the output unit 207 outputs the fact that no solution to the optimization problem can be obtained. The output method is similar to that in the above example. For example, the output unit 207 may output the fact that the inequality constraints conflict. In other words, for example, the output unit 207 may output which constraint does not have a solution. Therefore, the user can confirm which constraint cannot be satisfied. This makes it possible to easily change the condition of the user for the optimization problem. For example, when displaying a plurality of constraints on the terminal device 21, the output unit 207 may display conflicting constraints in an identifiable manner. As the example of displaying conflicting constraints in an identifiable manner, the output unit 207 may emphasize the conflicting constraints when displaying the plurality of constraints on the terminal device 21.

Next, the transformation unit 202 formulates the inequality constraint by introducing an auxiliary variable. As the formulation method, the example of Equation 8 may be used, or the example of Equation 18 may be used.

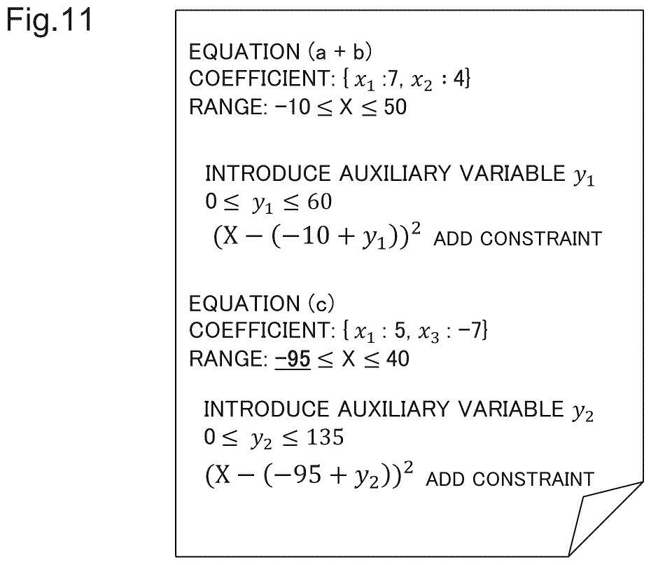

FIG. 11 is an explanatory diagram showing a formulation example. FIG. 11 shows an example of formulation using the example of Equation 8. The transformation unit 202 introduces the auxiliary variable y₁ in Equation (a+b). The range of the auxiliary variable y₁ is equal to or more than 0 and equal to or less than 60. A constraint shown in FIG. 11 is added.

The transformation unit 202 introduces the auxiliary variable y₂ in Equation (c). The range of the auxiliary variable y₂ is equal to or more than 0 and equal to or less than 135. A constraint shown in FIG. 11 is added.

The output unit 207 may output the inequality constraint and the transformed constraint in a comparable manner. Specifically, for example, the output unit 207 may display the inequality constraint and the transformed constraint in a comparable manner on the terminal device 21.

The solving unit 206 solves the optimization problem including the transformed constraint. The problem may be solved by an existing technique.

Next, the output unit 207 outputs a solution result. The output unit 207 may output a value of the variable at the time of obtaining the objective function of the optimization problem, a time required for solving the optimization problem, and an amount of hardware resources used for solving the optimization problem together with the solution result. The amount of hardware resources may be, for example, a memory usage amount. The output method is not particularly limited as described above.

### (Flowchart)

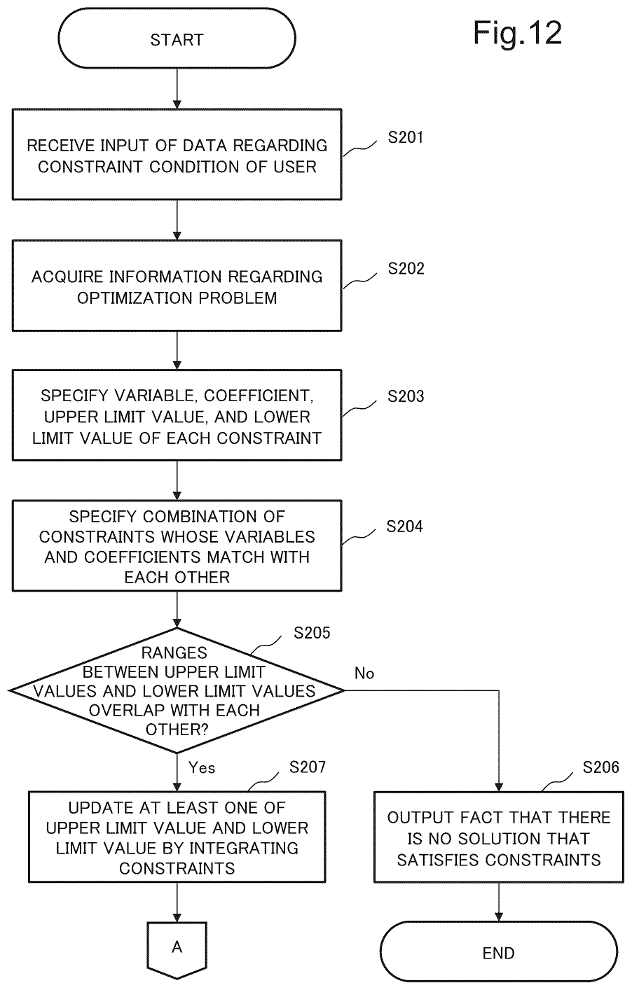

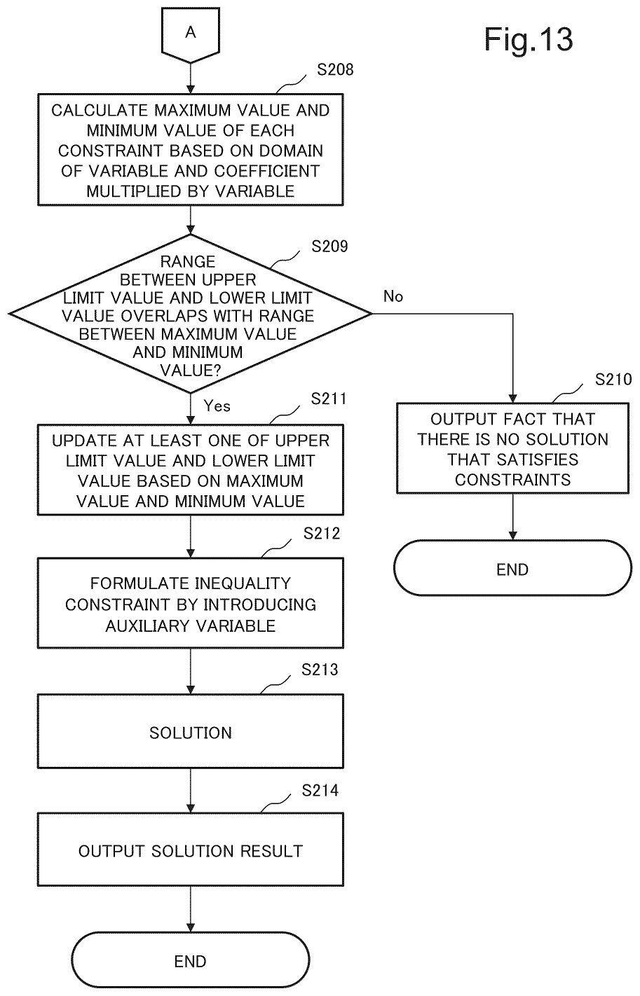

FIGS. 12 and 13 are flowcharts showing an operation example of the optimization system 20. The receiving unit 203 receives input of data regarding a constraint condition of the user (step S201). Next, the acquisition unit 204 acquires information regarding an optimization problem (step S202).

The analysis unit 205 specifies a variable, a coefficient, an upper limit value, and a lower limit value of each constraint (step S203). In step S203, the analysis unit 205 may store the specified variable, coefficient, upper limit value, and lower limit value of each constraint as dictionary data.

The update unit 201 specifies a combination of constraints whose variables and coefficients match with each other (step S204). The update unit 201 determines whether ranges between upper limit values and lower limit values overlap with each other for the combination of the constraints (step S205). When the ranges between the upper limit values and the lower limit values do not overlap with each other for the combination of the constraints (step S205: No), the output unit 207 outputs the fact that there is no solution that satisfies the constraints (step S206). The optimization system 20 ends the processing after step S206.

When the ranges between the upper limit values and the lower limit values overlap with each other for the combination of the constraints (step S205: Yes), the update unit 201 updates at least one of the upper limit value and the lower limit value by integrating the constraints of the combination (step S207).

Next, the update unit 201 calculates a maximum value and a minimum value of each constraint based on a domain of a variable and a coefficient multiplied by the variable (step S208). The update unit 201 determines whether the range between the upper limit value and the lower limit value overlaps with a range between the maximum value and the minimum value (step S209). When the range between the upper limit value and the lower limit value does not overlap with the range between the maximum value and the minimum value (step S209: No), the output unit 207 outputs the fact that there is no solution that satisfies the constraints (step S210). The optimization system 20 ends the processing after step S210.

Meanwhile, when the range between the upper limit value and the lower limit value overlaps with the range between the maximum value and the minimum value (step S209: Yes), the update unit 201 updates at least one of the upper limit value and the lower limit value based on the maximum value and the minimum value (step S211).

Next, the transformation unit 202 formulates the inequality constraint by introducing an auxiliary variable (step S212). The solving unit 206 solves the optimization problem including the transformed constraint (step S213). Next, the output unit 207 outputs a solution result (step S214). The optimization system 20 ends the processing after step S214.

Hereinabove, in the second example embodiment, in a case where a variable and a coefficient in an inequality constraint included in an optimization problem match with a variable and a coefficient in another constraint included in the optimization problem, the optimization system 20 updates at least one of an upper limit value and a lower limit value of the inequality constraint by integrating the inequality constraint with the another constraint. More specifically, in a case where a range between the upper limit value and the lower limit value of the inequality constraint overlaps with a range between an upper limit value and a lower limit value of the another constraint, the optimization system 20 integrates the inequality constraint with the another constraint. This makes it possible to reduce the range between the upper limit value and the lower limit value of the inequality constraint.

Meanwhile, in a case where the range between the upper limit value and the lower limit value of the inequality constraint does not overlap with the range between the upper limit value and the lower limit value of the another constraint, the optimization system 20 outputs the fact that no solution to the optimization problem can be obtained. This makes it possible to specify that there is no solution to the optimization problem without solving the optimization problem. When outputting the fact that no solution to the optimization problem can be obtained, the optimization system 20 may output the inequality constraint and the another constraint whose conditions conflict. Therefore, the user can confirm which constraint cannot be satisfied.

The optimization system 20 updates at least one of the upper limit value and the lower limit value of the inequality constraint based on at least one of the minimum value and the maximum value of a range calculated from a domain of the variable and the coefficient multiplied by the variable in the inequality constraint. More specifically, for example, in a case where the range overlaps with the range between the upper limit value and the lower limit value of the inequality constraint, the optimization system 20 updates at least one of the upper limit value and the lower limit value of the inequality constraint based on at least one of the minimum value and the maximum value of the range. This makes it possible to reduce the range between the upper limit value and the lower limit value of the inequality constraint.

In a case where the range does not overlap with the range between the upper limit value and the lower limit value of the inequality constraint, the optimization system 20 outputs the fact that no solution to the optimization problem can be obtained. This makes it possible to specify that there is no solution to the optimization problem without solving the optimization problem. When outputting the fact that no solution to the optimization problem can be obtained, the optimization system 20 may output the conflicting inequality constraints. Therefore, the user can confirm which constraint cannot be satisfied.

Hereinabove, description of the example embodiments ends. The example embodiments may be combined. For example, the formulation system 10 may include the update unit 101, the transformation unit 102, and the output unit 207. In the example embodiments, the formulation system 10 and the optimization system 20 may include each functional unit and part of information.

### Application Example

A combinatorial optimization problem can be applied to the fields of medical care and healthcare, distribution planning, digital marketing, drug discovery, and the like. Here, an example of applying each example embodiment to the fields of medical care and healthcare will be described.

For example, there will be described an application example of determining work shift schedules of medical workers in a medical facility, such as a nurse, a physical therapist, a caregiver, and a doctor, by using an artificial intelligence (AI) system including the optimization system 20 and the terminal device 21 described in the second example embodiment.

The nurse or doctor logs into the AI system by using the terminal device 21 and inputs data regarding a constraint condition such as a desired working day. The terminal device 21 transmits the input data to the formulation system. The receiving unit 203 receives the data regarding the constraint condition such as the desired working day from the terminal device 21.

The constraint condition included in the optimization problem is not limited to the information input from the terminal device 21 by the user such as the nurse or the doctor. For example, the acquisition unit 204 may acquire a constraint condition by using data stored in an external database. The acquisition unit 204 may acquire the number of workers determined for each number of days from the external database as a constraint condition of the optimization problem. The constraint condition of the optimization problem is not limited to the desired working day, and any information regarding a work shift of the medical workers can be used. For example, the constraint condition may be compatibility or a personal relationship between nurses or doctors. In a case where the constraint condition is compatibility between nurses or doctors, in the optimization problem, it is possible to schedule a work shift such that compatible nurses or doctors work at the same day and time.

For example, an inequality constraint regarding a desired schedule input by each nurse and an inequality constraint regarding a working condition of each nurse are included in the optimization problem. For example, an inequality constraint regarding a desired schedule input by a certain nurse and an inequality constraint regarding a working condition of the nurse may reduce a range of the schedule that the nurse can work. Further, for example, there may be no schedule on which a certain nurse can work because an inequality constraint regarding a desired schedule input by the nurse conflicts with an inequality constraint regarding a working condition of the nurse. Thus, the optimization system 20 can specify that there is no solution at the time of formulation before solving the optimization problem.

Hereinabove, the description of the application example ends. The example embodiments are not limited to the examples described above, and various modifications can be made. Configurations of the formulation system 10 and the optimization system 20 in the example embodiments are not particularly limited. For example, the functional units of the formulation system 10 may be implemented by one device such as a formulation device. The functional units of the optimization system 20 may be implemented by one device such as an optimization device. Alternatively, for example, the functional units or DBs of the formulation system 10 and the optimization system 20 may be implemented by different devices. For example, the functional units of the optimization system 20 may be configured by a plurality of servers and be implemented as the optimization system 20. For example, the optimization system 20 may be implemented by a database server including databases (DBs) and a server including the functional units. For example, the optimization system 20 may be implemented by a server including the update unit 201, the transformation unit 202, the receiving unit 203, the acquisition unit 204, and the analysis unit 205 and a server including the solving unit 206 and the output unit 207. In the example embodiments, each piece of information may include part of the above information. Each piece of information may include information other than the above information.

As in the AI system described in the application example, an entire system including either the formulation system 10 or the optimization system 20 and the terminal device 21 may be implemented.

Processing of generating information or the like to be displayed on the terminal device 21 may be performed by the output unit 207. The processing may also be performed by the terminal device 21. That is, the terminal device 21 generates information of a screen to be displayed on the display device provided in the terminal device 21 based on data received from the optimization system 20 and displays the screen on the display device.

### (Hardware Configuration Example of Computer)

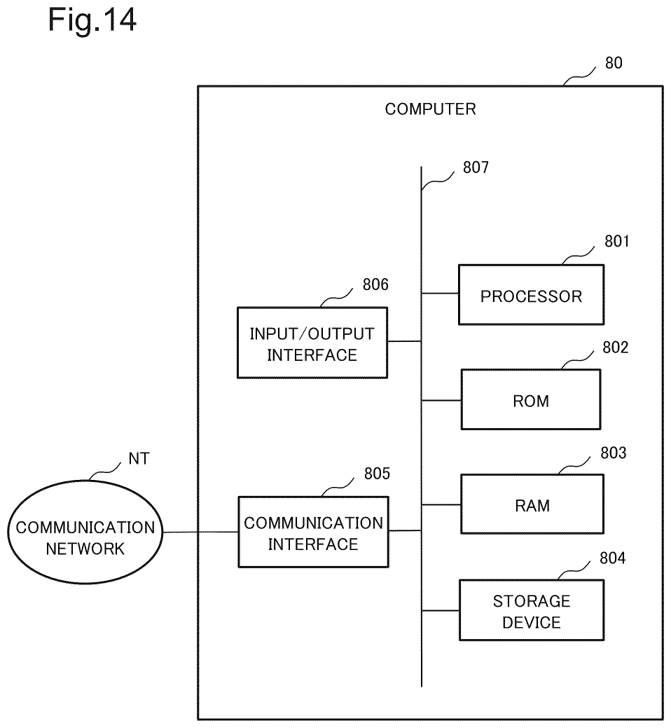

Next, a hardware configuration example where each device such as the formulation system 10, the optimization system 20, and the terminal device 21 described in the example embodiments is implemented by a computer will be described. FIG. 14 is an explanatory diagram showing a hardware configuration example of a computer. For example, some or all of the devices can be implemented by using any combination of a computer 80 shown in FIG. 14 and a program.

The computer 80 includes, for example, a processor 801, a read only memory (ROM) 802, a random access memory (RAM) 803, and a storage device 804. The computer 80 further includes a communication interface 805 and an input/output interface 806. The components are connected via, for example, a bus 807. The number of components is not particularly limited, and each component is one or more.

The processor 801 controls the entire computer 80. The processor 801 is not particularly limited and may be, for example, a central processing unit (CPU), a digital signal processor (DSP), a graphics processing unit (GPU), a physics processing unit (PPU), a tensor processing unit (TPU), a quantum processor, or a combination thereof.

The computer 80 includes the ROM 802, the RAM 803, the storage device 804, and the like. Examples of the storage device 804 include a semiconductor memory such as a flash memory, a hard disk drive (HDD), and a solid state drive (SSD). For example, the storage device 804 stores an operating system (OS) program, an application program, and programs according to the example embodiments. Alternatively, the ROM 802 stores the application program, the programs according to the example embodiments, and the like. The RAM 803 is used as a work area of the processor 801.

The processor 801 loads a program stored in the storage device 804, the ROM 802, or the like. Then, the processor 801 executes processing coded in the program. The processor 801 may download various programs via a communication network NT. The processor 801 functions as a part or all of the computer 80. Then, the processor 801 may execute processing or commands in the flowcharts of the drawings based on the programs.

The communication interface 805 is connected to the communication network NT such as a LAN or a wide area network (WAN) through a wireless or wired communication line. The communication network NT may include a plurality of communication networks NT. Therefore, the computer 80 is connected to an external device or an external computer 80 via the communication network NT. The communication interface 805 serves as an interface between the communication network NT and the inside of the computer 80. The communication interface 805 controls input/output of data to/from the external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and an audio output device that outputs audio. Examples of the input/output device include a touchscreen display. The input device, the output device, the input/output device, and the like may be built in the computer 80 or may be externally attached.

A hardware configuration of the computer 80 is an example. The computer 80 may include some of the components in FIG. 14. The computer 80 may include a component other than the components in FIG. 14. For example, the computer 80 may include a drive device. The processor 801 may read a program or data stored in a recording medium attached to the drive device or the like into the RAM 803. Examples of a non-transitory tangible recording medium include an optical disk, a flexible disk, a magnetic optical disk, and a universal serial bus (USB) memory. As described above, for example, the computer 80 may include the input device such as a keyboard and a mouse. The computer 80 may include an output device such as a display. The computer 80 may include the input device, the output device, and the input/output device.

The computer 80 may include various sensors (not illustrated). The types of the sensors are not particularly limited. The computer 80 may include an imaging device capable of capturing images and videos.

Hereinabove, the description of the hardware configuration of each device ends. There are various modification examples in a method of implementing each device. For example, each device may be implemented by any combination of a computer and a program different for each component. A plurality of components included in each device may be implemented by any combination of a single computer and a program.

Some or all of the components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. Those circuits may be a single integrated circuit. Alternatively, those circuits may be divided into a plurality of integrated circuits. The plurality of integrated circuits may be connected via a bus or the like.

In a case where some or all of the components of each device are implemented by a plurality of computers, circuits, or the like, the plurality of computers, circuits, or the like may be arranged in a centralized manner or in a distributed manner.

The formulation method described in the example embodiments may be executed by a computer such as the formulation system 10. The optimization method described in the example embodiments may be executed by a computer such as the optimization system 20.

Programs such as a formulation program and an optimization program described in the example embodiments are recorded in a computer-readable recording medium such as an HDD, an SSD, a flexible disk, an optical disk, a magnetic optical disk, and a USB memory. Each program is executed by being read from the recording medium by the computer. Each program may be distributed via the communication network NT.

The function of each component of the formulation system 10 and the function of each component of the optimization system 20 described above may be implemented by dedicated hardware such as a computer. Alternatively, each component may be implemented by software. Alternatively, each component may be implemented by a combination of hardware and software.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. The present disclosure may include example embodiments in which matters described in the present specification are appropriately combined or replaced as necessary. For example, matters described by using a specific example embodiment can be applied to other example embodiments as long as no inconsistency occurs. For example, a plurality of operations is sequentially described in the form of a flowchart, but the order of the description does not limit the order of performing the plurality of operations. Therefore, when the example embodiments are implemented, the order of the plurality of operations can be changed within a range that does not interfere with the content.

Some or all of the above example embodiments can also be described as the following supplementary notes. However, some or all of the above example embodiments are not limited to the following.

### Supplementary Note 1

A formulation system including:
an update unit that updates at least one of an upper limit value and a lower limit value of an inequality constraint included in an optimization problem in such a way as to reduce a range between the upper limit value and the lower limit value of the inequality constraint; and
a transformation unit that transforms the updated inequality constraint into an equality constraint by using an auxiliary variable having a domain determined by the upper limit value and the lower limit value of the updated inequality constraint.

### Supplementary Note 2

The formulation system according to Supplementary Note 1, in which
in a case where a variable and a coefficient in the inequality constraint match with a variable and a coefficient in another constraint included in the optimization problem, the update unit updates at least one of the upper limit value and the lower limit value of the inequality constraint by integrating the inequality constraint with the another constraint.

### Supplementary Note 3

The formulation system according to Supplementary Note 2, in which
in a case where the range between the upper limit value and the lower limit value of the inequality constraint overlaps with a range between an upper limit value and a lower limit value of the another constraint, the update unit integrates the inequality constraint with the another constraint.

### Supplementary Note 4

The formulation system according to Supplementary Note 3, further including
output unit that outputs the fact that no solution to the optimization problem can be obtained in a case where the range between the upper limit value and the lower limit value of the inequality constraint does not overlap with the range between the upper limit value and the lower limit value of the another constraint.

### Supplementary Note 5

The formulation system according to Supplementary Note 4, in which
the output unit outputs the fact that the inequality constraint and the another constraint conflict.

### Supplementary Note 6

The formulation system according to any one of Supplementary Notes 1 to 5, in which
the update unit updates at least one of the upper limit value and the lower limit value of the inequality constraint based on at least one of a minimum value and a maximum value of a range calculated from a domain of a variable and a coefficient multiplied by the variable in the inequality constraint.

### Supplementary Note 7

The formulation system according to Supplementary Note 6, in which
in a case where a range between the maximum value and the minimum value overlaps with the range between the upper limit value and the lower limit value of the inequality constraint, the update unit updates at least one of the upper limit value and the lower limit value of the inequality constraint based on at least one of the maximum value and the minimum value.

### Supplementary Note 8

The formulation system according to Supplementary Note 7, further including
output unit that outputs the fact that no solution to the optimization problem can be obtained in a case where the range between the maximum value and the minimum value does not overlap with the range between the upper limit value and the lower limit value of the inequality constraint.

### Supplementary Note 9

The formulation system according to any one of Supplementary Notes 1 to 8, in which
the transformation unit encodes the auxiliary variable by using a plurality of new variables whose number changes in accordance with the domain of the auxiliary variable.

### Supplementary Note 10

An optimization system, including:
one or a plurality of memories; and
a processor, in which
the processor
receives input of data regarding a constraint condition of a user for an optimization problem,
acquires information regarding the optimization problem including an inequality constraint showing the input data,
updates at least one of an upper limit value and a lower limit value of the inequality constraint included in the optimization problem in such a way as to reduce a range between the upper limit value and the lower limit value of the inequality constraint,
transforms the updated inequality constraint into an equality constraint by using an auxiliary variable having a domain determined by the upper limit value and the lower limit value of the updated inequality constraint,
solves the optimization problem including the transformed equality constraint, and
outputs a solution result.

### Supplementary Note 11

A formulation method, in which
a computer executes processing of
updating at least one of an upper limit value and a lower limit value of an inequality constraint included in an optimization problem in such a way as to reduce a range between the upper limit value and the lower limit value of the inequality constraint, and
transforming the updated inequality constraint into an equality constraint by using an auxiliary variable having a domain determined by the upper limit value and the lower limit value of the updated inequality constraint.

### Supplementary Note 12

A non-transitory computer-readable recording medium in which a program is recorded, the program causing a computer to execute processing of
updating at least one of an upper limit value and a lower limit value of an inequality constraint included in an optimization problem in such a way as to reduce a range between the upper limit value and the lower limit value of the inequality constraint, and
transforming the updated inequality constraint into an equality constraint by using an auxiliary variable having a domain determined by the upper limit value and the lower limit value of the updated inequality constraint.

### Supplementary Note 13

A program for causing a computer to execute processing of
updating at least one of an upper limit value and a lower limit value of an inequality constraint included in an optimization problem in such a way as to reduce a range between the upper limit value and the lower limit value of the inequality constraint, and
transforming the updated inequality constraint into an equality constraint by using an auxiliary variable having a domain determined by the upper limit value and the lower limit value of the updated inequality constraint.

### REFERENCE SIGNS LIST

10 Formulation system
20 Optimization system
21 Terminal device
80 Computer
101, 201 Update unit
102, 202 Transformation unit
203 Receiving unit
204 Acquisition unit
205 Analysis unit
206 Solving unit
207 Output unit
801 Processor
802 ROM
803 RAM
804 Storage device
805 Communication interface
806 Input/output interface
807 Bus
NT Communication network

What is claimed is:

1. A formulation system comprising:
one or more memory storing instructions; and
one or more processors configured to execute the instructions to:
update at least one of an upper limit value and a lower limit value of an inequality constraint included in an optimization problem in such a way as to reduce a range between the upper limit value and the lower limit value of the inequality constraint; and
transform the updated inequality constraint into an equality constraint by using an auxiliary variable having a domain determined by the upper limit value and the lower limit value of the updated inequality constraint.

2. The formulation system according to claim 1, wherein
the one or more processors are further configured to execute the instructions to:
in a case where a variable and a coefficient in the inequality constraint match with a variable and a coefficient in another constraint included in the optimization problem, update at least one of the upper limit value and the lower limit value of the inequality constraint by integrating the inequality constraint with the another constraint.

3. The formulation system according to claim 2, wherein
the one or more processors are further configured to execute the instructions to:
in a case where the range between the upper limit value and the lower limit value of the inequality constraint overlaps with a range between an upper limit value and a lower limit value of the another constraint, integrate the inequality constraint with the another constraint.

4. The formulation system according to claim 3, further comprising wherein
the one or more processors are further configured to execute the instructions to:
output the fact that no solution to the optimization problem can be obtained in a case where the range between the upper limit value and the lower limit value of the inequality constraint does not overlap with the range between the upper limit value and the lower limit value of the another constraint.

5. The formulation system according to claim 4, wherein
the one or more processors are further configured to execute the instructions to:
output the fact that the inequality constraint and the another constraint conflict.

6. The formulation system according to claim 1, wherein
the one or more processors are further configured to execute the instructions to:
update at least one of the upper limit value and the lower limit value of the inequality constraint based on at least one of a minimum value and a maximum value of a range calculated from a domain of a variable and a coefficient multiplied by the variable in the inequality constraint.

7. The formulation system according to claim 6, wherein
the one or more processors are further configured to execute the instructions to:
in a case where a range between the maximum value and the minimum value overlaps with the range between the upper limit value and the lower limit value of the inequality constraint, update at least one of the upper limit value and the lower limit value of the inequality constraint based on at least one of the maximum value and the minimum value.

8. The formulation system according to claim 7, wherein
the one or more processors are further configured to execute the instructions to:
output the fact that no solution to the optimization problem can be obtained in a case where the range between the maximum value and the minimum value does not overlap with the range between the upper limit value and the lower limit value of the inequality constraint.

9. The formulation system according to claim 1, wherein
the one or more processors are further configured to execute the instructions to:
encode the auxiliary variable by using a plurality of new variables whose number changes in accordance with the domain of the auxiliary variable.

10. A formulation method, wherein
a computer executes processing of
updating at least one of an upper limit value and a lower limit value of an inequality constraint included in an optimization problem in such a way as to reduce a range between the upper limit value and the lower limit value of the inequality constraint, and
transforming the updated inequality constraint into an equality constraint by using an auxiliary variable having a domain determined by the upper limit value and the lower limit value of the updated inequality constraint.

11. A non-transitory computer-readable recording medium in which a program is recorded, the program causing a computer to execute processing of
updating at least one of an upper limit value and a lower limit value of an inequality constraint included in an optimization problem in such a way as to reduce a range between the upper limit value and the lower limit value of the inequality constraint, and
transforming the updated inequality constraint into an equality constraint by using an auxiliary variable having a domain determined by the upper limit value and the lower limit value of the updated inequality constraint.
